(19) United States
(12) Patent Application Publication
(10) Pub. No.: US 2023/0416989 A1
(43) Pub. Date: Dec. 28, 2023

(54) CARBON FIBER PAPER, FLEXIBLE ROLLABLE CARBON PAPER MADE FROM THE CARBON FIBER BASE PAPER AND THE PREPARATION METHODS AND SYSTEMS THEREOF

(71) Applicant: SHANGHAI JAZZ NEW MATERIAL TECHNOLOGY CO., LTD., Shanghai (CN)

(72) Inventor: Xuefeng Lu, Shanghai (CN)

(21) Appl. No.: 18/253,389

(22) PCT Filed: Nov. 12, 2021
(86) PCT No.: PCT/CN2021/130339

§ 371 Date: May 17, 2023

(30) Foreign Application Priority Data
Nov. 18, 2020 (CN) 202011295554.0

(51) Int. Cl. D21H 13/50; D21H 25/04; D21H 27/30

(52) U.S. Cl. CPC D21H 13/50; D21H 25/04; D21H 27/30

(57) ABSTRACT

The present application discloses a flexible rollable carbon paper, and the carbon paper has a thickness of 0.15˜0.25 mm, a volume density of 0.20˜0.45 g/cm³, and a porosity of 70˜90%; a flexible strength of 2060 Mpa, and a bending degree of 60˜180°; a surface resistivity ≤100 mΩ-cm; and a thermal conductivity ≥0.8 W/(m·K). The present application also discloses the processing technology and related processing systems of the paper and its intermediates.

### TECHNICAL FIELD

The present invention relates to the technical field of preparation of high- performance carbon paper, and in particular to a carbon paper for fuel cells and its preparation method that meet different fluid diffusion requirements.

### BACKGROUND ART

With the advantages of high energy conversion efficiency, no pollution, fast start-up, long service life, high specific power and specific energy, proton exchange membrane fuel cells are widely used in the field of energy and energy-saving technologies. As the substrate of the gas diffusion layer of the core components of the fuel cell, the carbon paper is responsible for supporting the catalyst, air and water permeability, and fluid collection, so its quality is directly related to the performance of the fuel cell. Currently available carbon paper products in the world are mainly flake carbon fiber paper, and there is only one model of carbon fiber paper rolls launched by Toray in Japan. Compared to carbon fiber paper rolls, flake carbon fiber paper does not facilitate continuous production of subsequent microporous diffusion layers because of its thin and brittle nature. At present, carbon paper is usually prepared by wet copying combined with liquid thermosetting resin impregnation - carbonization process. This preparation method and the manufactured products have problems such as long preparation cycle, high energy consumption and environmental pollution.

### SUMMARY OF THE INVENTION

In response to the above-mentioned problems of the prior art, the applicant of the present invention provides a flexible rollable carbon paper and a preparation method thereof The present invention is more environmentally friendly, simpler and less costly than traditional carbon fiber paper preparation technology, and facilitates continuous production of subsequent microporous diffusion layers.

Some embodiments of the present application provide a flexible rollable carbon paper, and the carbon paper has a thickness of 0.15˜0.25 mm, a volume density of 0.2˜0.45 g/cm³, and a porosity of 70˜90%; a flexible strength of 20˜60 Mpa, and a bending degree of 60˜180°; a surface resistivity ≤100 mΩ-cm; and a thermal conductivity ≥0.8 W/(m·K).

Some embodiments of the present application provide a method of preparing the flexible rollable carbon paper, and the preparation method comprises the following steps:
step 1: performing carbon fiber matching;
step 2: preparing carbon fiber non-woven paper sheets by non-woven technology;
step 3: laminating the surface of multiple carbon fiber non-woven paper sheets to form a carbon fiber paper; and
step 4: producing the flexible rollable carbon paper by continuous heat treatment.

In some embodiments, the carbon fiber matching method in step 1 is as follows: short-cut the carbon fiber into long fibers of 25˜100 mm and short fibers of 1˜20 mm and control the mass ratio of long fibers and short fibers at 3:1˜1:3.

The method of preparing the carbon fiber non-woven paper sheets in step 2 comprises the following steps: step 2.1, opening the long and short carbon fibers by double-roller fiber opener respectively, using air as the dispersing medium and depending on a high-speed rotary roller to disperse the fiber raw material into single ones; and step 2.2, bringing the two types of fibers above into the blender through the airflow fiber conveyor at the same time, mix the long and short fibers through the airflow, and subsequently introduce to the airflow carding machine for further carding of the carbon fibers to form the carbon fiber non-woven paper sheets by the web formation technology.

The speed of the roller for long fiber opening in step 2.1 is 4000˜7500 rpm; the speed of the roller for short fiber opening is 2000˜3000 rpm.

The airflow fiber conveyor and the airflow carding machine in step 2.2 use compressed air as the medium, the gas flow rate of the airflow fiber conveyor for long fibers is 2545 m/s, the gas flow rate of the airflow fiber conveyor for short fibers is 5˜20 m/s, and the gas flow rate of the airflow carding machine is 15˜35 m/s;

The carbon fiber non-woven paper sheet in step 2.2 has a surface density of 10 to 30 g/m².

The process of surface lamination in step 3 is as follows: laminate a layer of thermoplastic resin film A and a carbon fiber non-woven paper sheet B, and then heat press them using an automatic laminating machine at 100˜220° C. to form carbon fiber paper.

The thermoplastic resin film is one or more of the following materials: thermoplastic phenolic resin film, polyethylene film, and polypropylene film; the resin film has a thickness of 0.01˜0.1 mm.

The lamination involves a total of 3 to 15 layers and the lamination is composed of a layer of thermoplastic resin film A, a carbon fiber non-woven sheet B, and a layer of thermoplastic resin film A in turn circularly (in the form of ABA, ABABA, ABABABABA, ABABABABA, ABABABABABA), or a layer of thermoplastic resin film, a carbon fiber non-woven paper sheet, two layers of thermoplastic resin film, a carbon fiber non-woven paper sheet, and a layer of thermoplastic resin (in the form of ABAABA, ABAABAABA, ABAABAABA, etc.)

The carbon fiber paper has a thickness of 0.15˜0.45 mm, and a density of 20˜200 g/cm².

The process of continuous heat treatment in step 4 is as follows: carbonize for 30˜180 min under the protection of nitrogen at 600 to 1100° C., followed by heat treatment for 30˜180 min under the protection of argon at 1400˜1800° C.

Other embodiments of the present application provide the carbon fiber paper for making the flexible rollable carbon paper, and it comprises at least a carbon fiber non-woven paper sheet and a layer of thermoplastic resin film laminated to at least one side of the carbon fiber non-woven paper sheet.

Other embodiments of the present application provide a method of preparing carbon fiber paper, characterized in that the preparation method comprises the steps as follows: step 1: performing carbon fiber matching; step 2: preparing carbon fiber non-woven paper sheets by non-woven technology; and step 3 laminating the surface of multiple carbon fiber non-woven paper sheets to form a carbon fiber paper;

Other embodiments of the present application provide a carbon fiber paper processing system comprising a short fiber cutting unit for cutting the carbon fiber to a desired shorter first length; a long fiber cutting unit for cutting the carbon fiber to a second length longer than the first length; a double-roller fiber opener for short fibers and a double-roller fiber opener for long fibers, for opening the cut short fibers and long fibers, respectively; an airflow fiber conveyor for short fibers, and an airflow fiber conveyor for long fibers, for conveying short fibers and long fibers to the blender, and for mixing long fibers and short fibers in the blender; an airflow carding machine for carding the mixed fibers output from the blender; a wet formation unit for to web formation processing of the fibers into the airflow carding machine to form carbon fiber non-woven paper sheets; and a laminating machine for laminating the formed carbon fiber non-woven paper sheets to form carbon fiber paper.

Further embodiments of the present application provide a carbon paper processing system comprising a short fiber cutting unit for cutting the carbon fiber to a desired shorter first length; a long fiber cutting unit for cutting the carbon fiber to a second length longer than the first length; a double-roller fiber opener for short fibers and a double-roller fiber opener for long fibers, for opening the cut short fibers and long fibers, respectively; an airflow fiber conveyor for short fibers, and an airflow fiber conveyor for long fibers, for conveying short fibers and long fibers to the blender, and for mixing long fibers and short fibers in the blender; an airflow carding machine for carding the mixed fibers output from the blender; a wet formation unit for to web formation processing of the fibers into the airflow carding machine to form carbon fiber non-woven paper sheets; a laminating machine for laminating the formed carbon fiber non-woven paper sheets to form carbon fiber paper; a carbonizing unit for carbonizing the carbon fiber paper, and a high-temperature treatment unit for graphitizing the carbon fiber paper that has been carbonized.

The beneficial technical effects of the present invention lie in that:
(1) Compared with the traditional methods and systems for manufacturing carbon paper, the use of non-woven technology for uniform blending of carbon fibers of different lengths facilitates the regulation of carbon paper properties.
(2) The carbon paper prepared by non-woven technology and laminating process has uniform distribution of carbon fibers and pores inside, thus making the obtained carbon paper uniform in performance.
(3) Compared with liquid thermosetting resin, which has high viscosity and tends to adhere to other objects and affects the quality of carbon paper, thermoplastic resin film has the advantages of clean and environmentally friendly production environment and uniform distribution of resin inside the carbon paper, providing a stable quality of carbon paper.
(4) Compared to the traditional liquid resin impregnation process, the use of laminating process reduces the damage to the carbon paper due to low strength in the liquid stage of resin.
(5) The use of the continuous heat treatment process enables the continuous production of carbon paper.
(6) The carbon paper for fuel cells prepared by the present invention has excellent electrical properties, thermal conductivity, as well as a series of advantages such as flexibility and rollability, and facilitates subsequent operations.

### BRIEF DESCRIPTION OF THE DRAWINGS

FIG. 1 shows a structure schematic diagram of the flexible rollable carbon paper and its preparation system provided in the embodiments of the present application;

FIG. 2 shows a flow chart of the flexible rollable carbon paper and its preparation method provided in the embodiments of the present application;

FIG. 3A˜3G show the structure schematic diagrams of the flexible rollable carbon fiber paper provided in the embodiments of the present application.

### DETAILED DESCRIPTION OF THE PREFERRED EMBODIMENTS

The present invention is described in detail below in combination with the drawings.

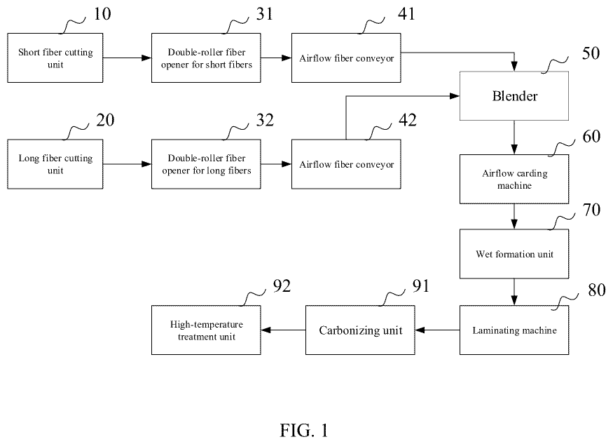

Embodiments of the present invention can be manufactured using a continuous processing system as shown in FIG. 1, or manufactured in stages and steps with the aid of equipment having the same or similar functions as the parts of the system in FIG. 1 to obtain the carbon fiber paper and carbon paper in the present invention.

The continuous processing system 100 provided in the embodiments of the present application includes a short fiber cutting unit 10 for cutting the carbon fiber to a desired shorter first length, a long fiber cutting unit 20 for cutting the carbon fiber to a desired second length longer than the first length, a double-roller fiber opener 31 for short fibers, and a double-roller fiber opener 32 for long fibers, used for opening the cut short fibers and the long fibers, respectively. Airflow fiber conveyors 41, 42 are used to convey short fibers and long fibers to the blender 50, both short fibers and long fibers are mixed in the blender 50, and carded in the airflow carding machine 60, and then sent to the wet formation unit 70 for wet formation processing to form carbon fiber non-woven paper; the formed carbon fiber non-woven paper sheets are fed into the laminating machine 80 to form carbon fiber paper, and then fed into the carbonizing unit 91 and the high-temperature treatment unit 92 for carbonization and graphitization, respectively. The non-woven paper sheets and the carbon fiber paper can be conveyed by a conveyor belt.

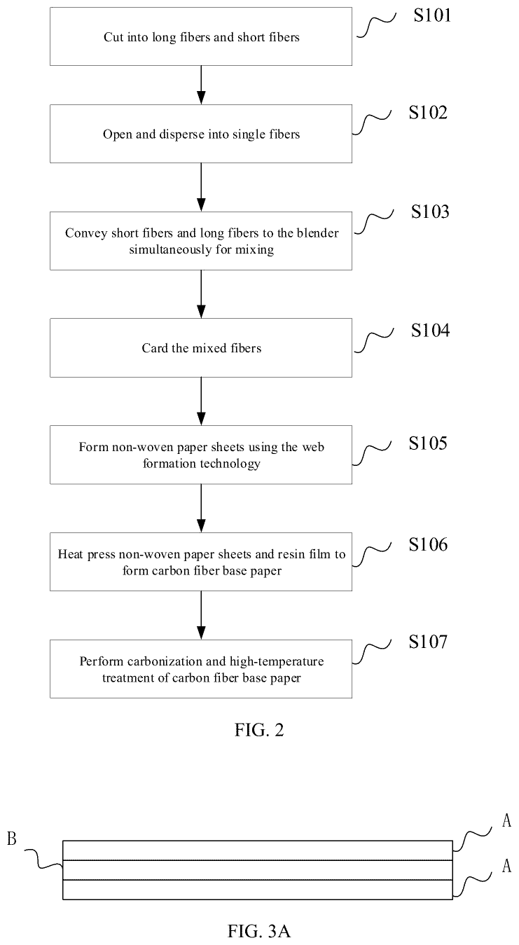

The steps for processing the carbon fiber paper and the carbon paper in this application are described as follows based on FIG. 2:

The first step is carbon fiber matching, step S101, and it includes short-cutting the carbon fiber into long fibers of 25˜100 mm and short fibers of 01˜20 mm, controlling the mass ratio of long fibers and short fibers at 3:1˜1:3.

The method of preparing the non-woven paper sheets comprises the following steps:

Step S102, open the long and short carbon fibers by double-roller fiber opener respectively, using air as the dispersing medium and depending on a high-speed rotary roller to disperse the fiber raw material into single ones;

Step S103, bring the two types of fibers above into the blender through the airflow fiber conveyor at the same time, mix the long and short fibers through the airflow;

Step S104, subsequently introduce to the airflow carding machine for further carding of the carbon fibers;

Step S105, form the carbon fiber non-woven paper sheets by the web formation technology. The web formation technology and equipment herein can be the process and equipment disclosed in Chinese invention application No. CN110129992A titled “A carbon fiber paper for fuel cells and a preparation method thereof”, disclosed on Aug. 16, 2019.

The speed of the roller for long fiber opening in step S102 is 4000˜7500 rpm; the speed of the roller for short fiber opening is 2000˜3000 rpm.

The airflow fiber conveyor and the airflow carding machine in steps S103 and S104 use compressed air as the medium, the gas flow rate of the airflow fiber conveyor for long fibers is 2545 m/s, the gas flow rate of the airflow fiber conveyor for short fibers is 5˜20 m/s, and the gas flow rate of the airflow carding machine is 15˜35 m/s.

At the end of step S104, the obtained carbon fiber non-woven paper sheet has a surface density of 5 to 40 g/m².

Then have the carbon fiber non-woven paper sheet undergo surface lamination, step S106, as follows: laminate at least a layer of thermoplastic resin film (A) and at least a carbon fiber non-woven paper sheet (B), and then heat press them using an automatic laminating machine at 100˜220° C. to form carbon fiber base paper.

The thermoplastic resin film is one or more of the following materials: thermoplastic phenolic resin film, polyethylene film, and polypropylene film; the resin film has a thickness of 0.01˜0.1 mm.

The lamination involves a total of 3 to 15 layers and the lamination is composed of a a layer of thermoplastic resin film (A), a carbon fiber non-woven sheet (B), and a layer of thermoplastic resin film (A) in turn circularly (in the form of ABA, ABABA, ABABABABA, ABABABABA, ABABABABABA), or a layer of thermoplastic resin film, a carbon fiber non-woven paper sheet, two layers of thermoplastic resin film, a carbon fiber non-woven paper sheet, and a layer of thermoplastic resin (in the form of ABAABA, ABAABAABA, ABAABAABA, etc.)

The carbon fiber paper obtained after lamination has a thickness of 0.15˜0.45 mm, and a density of 20˜200 g/cm².

Finally, have the carbon fiber paper undergo a continuous heat treatment, step S107, as follows: carbonize for 30˜180 min under the protection of nitrogen at 600 to 1100° C., followed by graphitization for 30˜180 min under the protection of argon at a high temperature of 1400˜1800° C.

The features and advantages of the present application are further explained below by describing specific embodiments hereof

### Embodiment 1

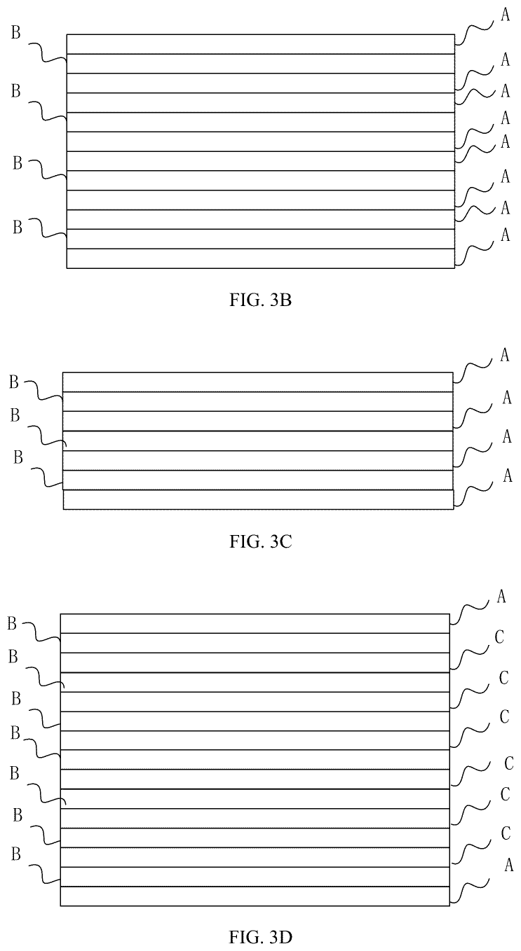

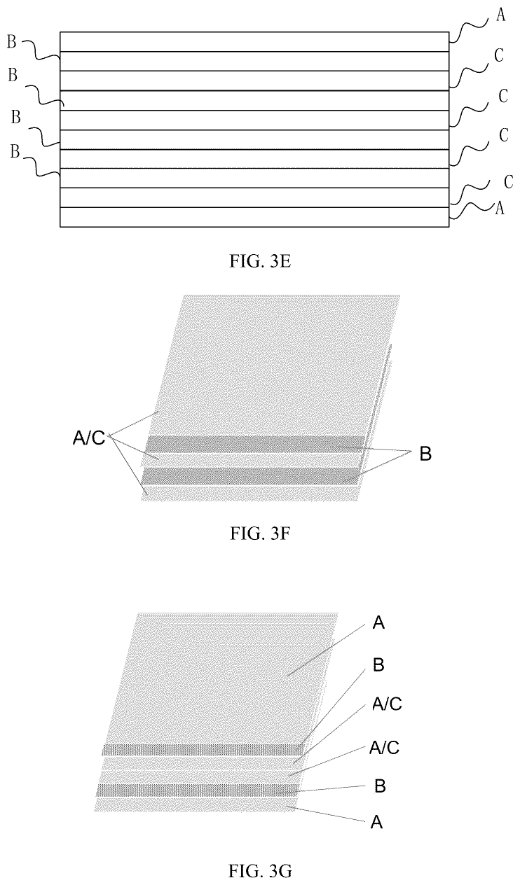

A method of preparing the flexible rollable carbon paper, the preparation method comprises the following steps:
(1) Short-cut the carbon fiber into long fibers of about 25 mm and short fibers of about 5 mm, and control the mass ratio of long fibers and short fibers at 3:1.
(2) Open the carbon fiber with a double-roller fiber opener, use air as the dispersing medium and depend on a high-speed rotary roller with a speed of 4,000 rpm to disperse the long fiber raw materials into single fibers; and depend on a high-speed rotary roller with a speed of 2,000 rpm to disperse the short fiber raw materials into single fibers. Bring the above two types of fibers into the blender through the airflow fiber conveyor at the same time, with the gas flow rate of the airflow conveyor for long fibers at 25 m/s, the gas flow rate of the airflow conveyor for short fibers at 8 m/s, and mix both long fibers and short fibers having the air fly towards and over each other, then introduce the mixed fibers to the airflow carding machine with the gas flow rate of 16 m/s for further carding of carbon fibers, and finally form carbon fiber non-woven paper sheets with the surface density of about 30 g/m² using the web formation technology.
(3) Laminate a layer of thermoplastic phenolic resin film A with a thickness of 0.1 mm, a carbon fiber non-woven paper sheet B and a layer of thermoplastic phenolic resin film A with a thickness of 0.1 mm, and form carbon fiber paper by heat pressing using an automatic laminating machine at 200° C.; the carbon fiber paper has a thickness of 0.15 mm and a surface density of 33 g/m², as shown in FIG. 3A.
(4) Perform pretreatment for 45 min at 1000° C. under the protection of nitrogen, followed by heat treatment at 1800° C. for 30 min under the protection of argon.

The carbon paper prepared has a thickness of 0.15 mm, a bulk density of 0.22 g/cm³, a porosity of 87.8%; a flexible strength of 20 Mpa, a bending degree of 65.5°; a surface resistivity of 95 mΩ·cm; and a thermal conductivity of 1.0 W/(m·K)

### Embodiment 2

A method of preparing the flexible rollable carbon paper, the preparation method comprises the following steps:
(1) Short-cut the carbon fiber into long fibers of 100 mm and short fibers of 20 mm, and control the mass ratio of long fibers and short fibers at 1:3.
(2) Open the carbon fiber with a double-roller fiber opener, use air as the dispersing medium and depend on a high-speed rotary roller with a speed of 7500 rpm to disperse the long fiber raw materials into single fibers; and depend on a high-speed rotary roller with a speed of 3000 rpm to disperse the short fiber raw materials into single fibers. Bring the above two types of fibers into the blender through the airflow fiber conveyor at the same time, with the gas flow rate of the airflow conveyor for long fibers at 45 m/s, the gas flow rate of the airflow conveyor for short fibers at 20 m/s, and mix both long fibers and short fibers having the air fly towards and over each other, then introduce the mixed fibers to the airflow carding machine with the gas flow rate of 32 m/s for further carding of carbon fibers, and finally form carbon fiber non-woven paper sheets with the surface density of 15 g/m² using the web formation technology.
(3) Laminate a layer of polypropylene resin film with a thickness of 0.02 mm, a carbon fiber non-woven paper sheet B and a layer of polypropylene resin film A with a thickness of 0.02 mm in turn circularly in the form of ABAABAABAABA, and form carbon fiber paper by heat pressing using an automatic laminating machine at 175° C.; the carbon fiber paper has a thickness of 0.20 mm and a surface density of 88 g/m², as shown in FIG. 3B.
(4) Perform pretreatment for 180 min at 600° C. under the protection of nitrogen, followed by heat treatment at 1500° C. for 180 min under the protection of argon;

The carbon paper prepared has a thickness of 0.20 mm, a bulk density of 0.38 g/cm³, a porosity of 80.6%; a flexible strength of 42 Mpa, a bending degree of 103.4°; a surface resistivity of 80 mΩ·cm; and a thermal conductivity of 1.4 W/(m·K)

### Embodiment 3

A method of preparing the flexible rollable carbon paper, the preparation method comprises the following steps:
(1) Short-cut the carbon fiber into long fibers of 50 mm and short fibers of 10 mm, and control the mass ratio of long fibers and short fibers at 1:1.
(2) Open the carbon fiber with a double-roller fiber opener, use air as the dispersing medium and depend on a high-speed rotary roller with a speed of 5200 rpm to disperse the long fiber raw materials into single fibers; and depend on a high-speed rotary roller with a speed of 2400 rpm to disperse the short fiber raw materials into single fibers. Bring the above two types of fibers into the blender through the airflow fiber conveyor at the same time, with the gas flow rate of the airflow conveyor for long fibers at 32 m/s, the gas flow rate of the airflow conveyor for short fibers at 15 m/s, and mix both long fibers and short fibers having the air fly towards and over each other, then introduce the mixed fibers to the airflow carding machine with the gas flow rate of 20 m/s for further carding of carbon fibers, and finally form carbon fiber non-woven paper sheets with the surface density of 20 g/m² using the web formation technology.
(3) Laminate a layer of polyethylene resin film with a thickness of 0.06 mm and a carbon fiber non-woven paper sheet B in the form of ABABABA, and form carbon fiber paper by heat pressing using an automatic laminating machine at 120° C.; the carbon fiber paper has a thickness of 0.25 mm and a surface density of 70 g/m², as shown in FIG. 3C.
(4) Perform pretreatment for 150 min at 700° C. under the protection of nitrogen, followed by heat treatment at 1600° C. for 45 min under the protection of argon;

The carbon paper prepared has a thickness of 0.25 mm, a bulk density of 0.25 g/cm³, a porosity of 86.1%; a flexible strength of 53 Mpa, a bending degree of 148°; a surface resistivity of 82 mΩ·cm; and a thermal conductivity of ≤1.32 W/(m·K)

### Embodiment 4

A method of preparing the flexible rollable carbon paper, the preparation method comprises the following steps:

(1) Short-cut the carbon fiber into long fibers of 60 mm and short fibers of 15 mm, and control the mass ratio of long fibers and short fibers at 2:1.

(2) Open the carbon fiber with a double-roller fiber opener, use air as the dispersing medium and depend on a high-speed rotary roller with a speed of 4800 rpm to disperse the long fiber raw materials into single fibers; and depend on a high-speed rotary roller with a speed of 2600 rpm to disperse the short fiber raw materials into single fibers. Bring the above two types of fibers into the blender through the airflow fiber conveyor at the same time, with the gas flow rate of the airflow conveyor for long fibers at 32 m/s, the gas flow rate of the airflow conveyor for short fibers at 15 m/s, and mix both long fibers and short fibers having the air fly towards and over each other, then introduce the mixed fibers to the airflow carding machine with the gas flow rate of 25 m/s for further carding of carbon fibers, and finally form carbon fiber non-woven paper sheets with the surface density of 10 g/m² using the web formation technology.
(3) Laminate a layer of phenolic resin film with a thickness of 0.05 mm, a carbon fiber non-woven paper sheet B and a layer of polyethylene resin film C with a thickness of 0.01 mm in the form of ABCBCBCBCBCBCBA, and form carbon fiber paper by heat pressing using an automatic laminating machine at 220° C.; the carbon fiber paper has a thickness of 0.25 mm and a surface density of 90 g/m², as shown in FIG. 3D.
(4) Perform pretreatment at 850° C. under the protection of nitrogen, followed by heat treatment at 1550° C. under the protection of argon;

The carbon paper prepared has a thickness of 0.25 mm, a bulk density of 0.31 g/cm³, a porosity of 82.7%; a flexible strength of 58.8 Mpa, a bending degree of 180°; a surface resistivity of 92 mΩ·cm; and a thermal conductivity of 1.22 W/(m·K).

### Embodiment 5

A method of preparing the flexible rollable carbon paper, the preparation method comprises the following steps:
(1) Short-cut the carbon fiber into long fibers of 80 mm and short fibers of 18 mm, and control the mass ratio of long fibers and short fibers at 1:2.
(2) Open the carbon fiber with a double-roller fiber opener, use air as the dispersing medium and depend on a high-speed rotary roller with a speed of 6800 rpm to disperse the long fiber raw materials into single fibers; and depend on a high-speed rotary roller with a speed of 2800 rpm to disperse the short fiber raw materials into single fibers. Bring the above two types of fibers into the blender through the airflow fiber conveyor at the same time, with the gas flow rate of the airflow conveyor for long fibers at 40 m/s, the gas flow rate of the airflow conveyor for short fibers at 18 m/s, and mix both long fibers and short fibers having the air fly towards and over each other, then introduce the mixed fibers to the airflow carding machine with the gas flow rate of 32 m/s for further carding of carbon fibers, and finally form carbon fiber non-woven paper sheets with the surface density of 20 g/m² using the web formation technology.
(3) Laminate a layer of thermoplastic phenolic resin film with a thickness of 0.03 mm, a carbon fiber non-woven paper sheet B and a layer of polypropylene film C with a thickness of 0.075 mm in the form of ABCBCBCBCA, and form carbon fiber paper by heat pressing using an automatic laminating machine at 200° C.; the carbon fiber paper has a thickness of 0.18 mm and a surface density of 102 g/m², as shown in FIG. 3E.
(4) Perform pretreatment for 100 min at 850° C. under the protection of nitrogen, followed by heat treatment at 1650° C. for 45 min under the protection of argon;

The carbon paper prepared has a thickness of 0.18 mm, a bulk density of 0.45 g/cm³, a porosity of 72%; a flexible strength of 43.2 Mpa, a bending degree of 163°; a surface resistivity of 83 mΩ·cm; and a thermal conductivity of 1.3 W/(m·K).

### Embodiment 6

A method of preparing the flexible rollable carbon paper, the preparation method comprises the following steps:
(1) Short-cut the carbon fiber into long fibers of 25 mm and short fibers of 1 mm, and control the mass ratio of long fibers and short fibers at 2:1.
(2) Open the carbon fiber with a double-roller fiber opener, use air as the dispersing medium and depend on a high-speed rotary roller with a speed of 6800 rpm to disperse the long fiber raw materials into single fibers; and depend on a high-speed rotary roller with a speed of 2800 rpm to disperse the short fiber raw materials into single fibers. Bring the above two types of fibers into the blender through the airflow fiber conveyor at the same time, with the gas flow rate of the airflow conveyor for long fibers at 28 m/s, the gas flow rate of the airflow conveyor for short fibers at 5 m/s, and mix both long fibers and short fibers having the air fly towards and over each other, then introduce the mixed fibers to the airflow carding machine with the gas flow rate of 15 m/s for further carding of carbon fibers, and finally form carbon fiber non-woven paper sheets with the surface density of 5 g/m² using the web formation technology.
(3) Laminate a layer of polypropylene film with a thickness of 0.1 mm in the form of ABABABABABA, and form carbon fiber paper by heat pressing using an automatic laminating machine at 100° C.; the carbon fiber paper has a thickness of 0.15 mm and a surface density of 45 g/m².
(4) Perform pretreatment for 30 min at 1100° C. under the protection of nitrogen, followed by heat treatment at 1400° C. for 30 min under the protection of argon;

The carbon paper prepared has a thickness of 0.15 mm, a bulk density of 0.2 g/cm³, a porosity of 90%; a flexible strength of 20 Mpa, a bending degree of 60°; a surface resistivity of 100 mΩ·cm; and a thermal conductivity of 0.8 W/(m·K)

### Embodiment 7

A method of preparing the flexible rollable carbon paper, the preparation method comprises the following steps:

(1) Short-cut the carbon fiber into long fibers of 90 mm and short fibers of 16 mm, and control the mass ratio of long fibers and short fibers at 1:2.

(2) Open the carbon fiber with a double-roller fiber opener, use air as the dispersing medium and depend on a high-speed rotary roller with a speed of 7200 rpm to disperse the long fiber raw materials into single fibers; and depend on a high-speed rotary roller with a speed of 2800 rpm to disperse the short fiber raw materials into single fibers. Bring the above two types of fibers into the blender through the airflow fiber conveyor at the same time, with the gas flow rate of the airflow conveyor for long fibers at 40 m/s, the gas flow rate of the airflow conveyor for short fibers at 18 m/s, and mix both long fibers and short fibers having the air fly towards and over each other, then introduce the mixed fibers to the airflow carding machine with the gas flow rate of 35 m/s for further carding of carbon fibers, and finally form carbon fiber non-woven paper sheets with the surface density of 40 g/m² using the web formation technology.
(3) Laminate a layer of polyester film with a thickness of 0.1 mm in the form of ABAABAABAABA, and form carbon fiber paper by heat pressing using an automatic laminating machine at 140° C.; the carbon fiber paper has a thickness of mm and a surface density of 168 g/m²;
(4) Perform pretreatment for 30 min at 800° C. under the protection of nitrogen, followed by heat treatment at 1500° C. for 30 min under the protection of argon;

The carbon paper prepared has a thickness of 0.25 mm, a bulk density of 0.45 g/cm³, a porosity of 70%; a flexible strength of 32 Mpa, a bending degree of 78°; a surface resistivity of 76 mΩ·cm; and a thermal conductivity of 1.5 W/(m·K).

The method and system provided in this application and the carbon fiber paper and carbon paper prepared based on the method and system are not limited to the parameters and settings given in the above embodiments. All carbon fiber paper and carbon paper as well as the preparation processes and systems thereof that conform to the basic characteristics of the application should be included in the scope of protection of the present application. For example, other possible laminar structures of carbon fiber paper are also given in FIG. 3F and 3G. And the present application also includes the case where two non-woven paper sheets are set next to each other to form a carbon fiber paper.

Preferred embodiments of the present invention are documented above, but the spirit and scope of the present invention is not limited to the specific elements disclosed herein. Those skilled in the art can make further embodiments and applications within the spirit and scope of the present invention by combining and extending each of the above embodiments at will in accordance with the teachings of the present invention. The spirit and scope of the invention is not limited by specific embodiments, but by the claims

The present invention may be realized based on the following examples:
1. A flexible rollable carbon paper is characterized in that the carbon paper has a thickness of 0.150.25 mm, a volume density of 0.20˜0.45 g/cm³, and a porosity of 70˜90%; a flexible strength of 2060 Mpa, and a bending degree of 60˜180°; a surface resistivity ≤100 mΩ·cm; and a thermal conductivity ≥0.8 W/(m·K).
2. A method of preparing the flexible rollable carbon paper as set forth in example 1 is characterized in that the preparation method comprises the following steps:
step 1: performing carbon fiber matching;
step 2: preparing carbon fiber non-woven paper sheets by non-woven technology;
step 3: laminate the surface of multiple carbon fiber non-woven paper sheets to form a carbon fiber paper; and
step (4) producing the flexible rollable carbon paper by continuous heat treatment.
3. The method of preparing the flexible rollable carbon paper as set forth in example 2 is characterized in that the carbon fiber matching in step 1 includes short-cutting the carbon fiber into long fibers of 25˜100 mm and short fibers of 1˜20 mm, controlling the mass ratio of long fibers and short fibers at 3:1˜1:3.
4. The method of preparing the flexible rollable carbon paper as set forth in example 3 is characterized in that the method of preparing the carbon fiber non-woven paper sheets in step 2 comprises the following steps:
Open the long and short carbon fibers separately to disperse them into single ones;
Bring the opened long and short fibers into the blender through the airflow fiber conveyor at the same time, mix the long and short fibers through the airflow, and subsequently introduce them into the airflow carding machine for further carding of the carbon fibers to form the carbon fiber non-woven paper sheets by the web formation technology.
5. The method of preparing the flexible rollable carbon paper as set forth in example 4 is characterized in that:
The long and short fiber carbon fibers are opened separately using a double-roller fiber opener, with the air used as the dispersing medium, depending on a high-speed rotary roller.
6. The method of preparing the flexible rollable carbon paper as set forth in example 5 is characterized in that the speed of the roller for long fiber opening in step 2.1 is 4000˜7500 rpm; the speed of the roller for short fiber opening is 2000˜3000 rpm.
7. The method of preparing the flexible rollable carbon paper as set forth in example 6 is characterized in that the opened long and short fibers are simultaneously brought into the blender through the airflow fiber conveyor.
8. The method of preparing the flexible rollable carbon paper as set forth in example 6 is characterized in that the airflow fiber conveyor and the airflow carding machine in step 2.2 use compressed air as the medium, the gas flow rate of the airflow fiber conveyor for long fibers is 25˜45 m/s, the gas flow rate of the airflow fiber conveyor for short fibers is 5˜20 m/s, and the gas flow rate of the airflow carding machine is 15˜35 m/s.
9. The method of preparing the flexible rollable carbon paper as set forth in example 8 is characterized in that the carbon fiber non-woven paper sheet in step (2) has a surface density of 5 to 40 g/m².
The method of preparing the flexible rollable carbon paper as set forth in example 9 is characterized in that the process of surface lamination in step (3) is as follows: laminate a layer of thermoplastic resin film (A) and a carbon fiber non-woven paper sheet (B), and then heat press them using an automatic laminating machine at 100˜220° C. to form carbon fiber paper.
11. The method of preparing the flexible rollable carbon paper as set forth in example 9 is characterized in that the process of continuous heat treatment in step (4) is as follows: carbonize for 30˜180 min under the protection of nitrogen at 600 to 1100° C., followed by heat treatment for 30˜180 min under the protection of argon at 1400˜1800° C.
12. The method of preparing the flexible rollable carbon paper as set forth in example 11 is characterized in that the thermoplastic resin film is one or more of the following materials: thermoplastic phenolic resin film, epoxy resin film, polyethylene film, and polypropylene film; the resin film has a thickness of mm.
13. The method of preparing the flexible rollable carbon paper as set forth in example 11 is characterized in that the lamination involves a total of 3˜12 layers and the lamination is composed of a layer of thermoplastic resin film (A), a carbon fiber non-woven sheet (B), and a layer of thermoplastic resin film (A) in the form of (ABA), (ABABABA), (ABABABA), (ABABABABA), (ABABABABA), or (ABABABABABA) in turn circularly.
14. The method of preparing the flexible rollable carbon paper as set forth in example 11 is characterized in that:
the lamination involves a total of 3˜12 layers and the lamination is composed of a layer of thermoplastic resin film (A), a carbon fiber non-woven paper sheet (B), two layers of thermoplastic resin film (AA), a carbon fiber non-woven paper sheet (B), and a layer of thermoplastic resin film (A) in the form of (ABAABA), (ABAABAABA), or (ABAABAABAABA).
15. The carbon fiber paper for making the flexible rollable carbon paper as set forth in example 1 is characterized in that it comprises at least a carbon fiber non-woven paper sheet and a layer of thermoplastic resin film laminated to at least one side of the carbon fiber non-woven paper sheet.
16. The carbon fiber paper as set forth in example 15 is characterized in that the first side of the carbon fiber non-woven sheet is laminated with a first thermoplastic resin film and the second side is laminated with a second thermoplastic resin film.
17. The carbon fiber paper as set forth in example 16 is characterized in that the first thermoplastic resin film and the second thermoplastic resin film are of the same material.
18. The carbon fiber paper as set forth in example 17 is characterized in that the first thermoplastic resin film and the second thermoplastic resin film are of different materials.
19. The carbon fiber paper as set forth in any one of examples 16˜18 is characterized in that the thermoplastic resin film is one or more of the following materials: thermoplastic phenolic resin film, epoxy resin film, polyethylene film, and polypropylene film.
20. The carbon fiber paper as set forth in example 19 is characterized in that the resin film has a thickness of 0.01˜0.1 mm.
21. The carbon fiber paper as set forth in any one of examples 15˜20 is characterized in that the carbon fiber paper has a thickness of 0.15˜0.45 mm, and a density of 20˜200 g/cm².
22. A method of preparing the carbon fiber paper as set forth in examples 15˜21 is characterized in that the preparation method comprises the following steps:
Step (1) Perform carbon fiber matching;
Step (2) Prepare carbon fiber non-woven paper sheets by non-woven technology;
Step (3) Laminate the surface of multiple carbon fiber non-woven paper sheets to form a carbon fiber paper.
23. The method of preparing the carbon fiber paper as set forth in example 22 is characterized in that the carbon fiber matching in step (1) includes short-cutting the carbon fiber into long fibers of 25˜100 mm and short fibers of 1˜20 mm, controlling the mass ratio of long fibers and short fibers at 3:1˜1:3.
24. The method of preparing the carbon fiber paper as set forth in example 23 is characterized in that the method of preparing the carbon fiber non-woven paper sheets in step (2) comprises the following steps:
Open the long and short carbon fibers separately to disperse them into single ones;
Bring the opened long and short fibers into the blender through the airflow fiber conveyor at the same time, mix the long and short fibers through the airflow, and subsequently introduce them into the airflow carding machine for further carding of the carbon fibers to form the carbon fiber non-woven paper sheets by the web formation technology.
The method of preparing the carbon fiber paper as set forth in example 24 is characterized in that:
The long and short fiber carbon fibers are opened separately using a double-roller fiber opener, with the air used as the dispersing medium, depending on a high-speed rotary roller.
26. The method of preparing the carbon fiber paper as set forth in example 25 is characterized in that the speed of the roller for long fiber opening in step (2) \textcircled{1} is 4000˜7500 rpm; the speed of the roller for short fiber opening is 2000˜3000 rpm.
27. The method of preparing the carbon fiber paper as set forth in example 26 is characterized in that the opened long and short fibers are simultaneously brought into the blender through the airflow fiber conveyor.
28. The method of preparing the carbon fiber paper as set forth in example 26 is characterized in that the airflow fiber conveyor and the airflow carding machine in step (2) \textcircled{2} use compressed air as the medium, the gas flow rate of the airflow fiber conveyor for long fibers is 25˜45 m/s, the gas flow rate of the airflow fiber conveyor for short fibers is 5˜20 m/s, and the gas flow rate of the airflow carding machine is 15˜35 m/s.
29. The method of preparing the carbon fiber paper as set forth in example 28 is characterized in that the carbon fiber non-woven paper sheet in step (2) has a surface density of 5 to 40 g/m².
The method of preparing the carbon fiber paper as set forth in example 29 is characterized in that the process of surface lamination in step (3) is as follows: laminate a layer of thermoplastic resin film (A) and a carbon fiber non-woven paper sheet (B), and then heat press them using an automatic laminating machine at 100˜220° C. to form carbon fiber paper.
31. The method of preparing the carbon fiber paper as set forth in example 30 is characterized in that the thermoplastic resin film is one or more of the following materials: thermoplastic phenolic resin film, polyester film, polyethylene film, and polypropylene film; the resin film has a thickness of 0.01˜0.1 mm.
32. The method of preparing the carbon fiber paper as set forth in example 30 is characterized in that the lamination involves a total of 3˜12 layers and the lamination is composed of a layer of thermoplastic resin film (A), a carbon fiber non-woven sheet (B), and a layer of thermoplastic resin film (A) in the form of (ABA), (ABABABA), (ABABABA), (ABABABABA), (ABABABABA), or (ABABABABABA) in turn circularly.
33. The method of preparing the carbon fiber paper as set forth in example 30 is characterized in that:
The lamination involves a total of 3˜12 layers and the lamination is composed of a layer of thermoplastic resin film (A), a carbon fiber non-woven sheet (B), and a layer of thermoplastic resin film (A) in the form of (ABA), (ABABABA), (ABABABA), (ABABABABA), (ABABABABA), or (ABABABABABA) in turn circularly.
34. A carbon fiber paper processing system is characterized in that it comprises:
A short fiber cutting unit for cutting the carbon fiber to a desired shorter first length;
A long fiber cutting unit for cutting the carbon fiber to a second length longer than the first length;
A double-roller fiber opener for short fibers and a double-roller fiber opener for long fibers, for opening the cut short fibers and long fibers, respectively;
An airflow fiber conveyor for short fibers, and an airflow fiber conveyor for long fibers, for conveying short fibers and long fibers to the blender, and for mixing long fibers and short fibers in the blender;
An airflow carding machine for carding the mixed fibers output from the blender;
A wet formation unit for to web formation processing of the fibers into the airflow carding machine to form carbon fiber non-woven paper sheets;
A laminating machine for laminating the formed carbon fiber non-woven paper sheets to form carbon fiber paper.
35. A carbon paper processing system is characterized in that it comprises:
A short fiber cutting unit for cutting the carbon fiber to a desired shorter first length;
A long fiber cutting unit for cutting the carbon fiber to a second length longer than the first length;
A double-roller fiber opener for short fibers and a double-roller fiber opener for long fibers, for opening the cut short fibers and long fibers, respectively;
An airflow fiber conveyor for short fibers, and an airflow fiber conveyor for long fibers, for conveying short fibers and long fibers to the blender, and for mixing long fibers and short fibers in the blender;
An airflow carding machine for carding the mixed fibers output from the blender;
A wet formation unit for to web formation processing of the fibers into the airflow carding machine to form carbon fiber non-woven paper sheets;
A laminating machine for laminating the formed carbon fiber non-woven paper sheets to form carbon fiber;
A carbonizing unit for carbonizing the carbon fiber paper, and
A high-temperature treatment unit for graphitizing the carbon fiber paper that has been carbonized.

1. A flexible rollable carbon paper, characterized in that the carbon paper has a thickness of 0.15˜0.25 mm, a volume density of 0.20˜0.45 g/cm³, and a porosity of 70˜90%; a flexible strength of 20˜60 Mpa, and a bending degree of 60˜180°; a surface resistivity ≤100 mΩ·cm; and a thermal conductivity ≥0.8 W(m·K);
the method for preparing the same is composed of the following steps:
step 1: performing carbon fiber matching;
step 2: preparing carbon fiber non-woven paper sheets by non-woven technology;
step 3: laminating the surface of multiple carbon fiber non-woven paper sheets to form a carbon fiber paper; and
step 4: producing the flexible rollable carbon paper by continuous heat treatment
wherein the process of surface lamination in step 3 is as follows: laminate a layer of thermoplastic resin film (A) and a carbon fiber non-woven paper sheet (B), and then heat press them using an automatic laminating machine at 100˜220° C. to form carbon fiber paper;
wherein the carbon fiber matching in step 1 includes short-cutting the carbon fiber into long fibers of 25˜100 mm and short fibers of 1˜20 mm, controlling the mass ratio of long fibers and short fibers at 3:1˜1:3,
wherein the method of preparing the carbon fiber non-woven paper sheets in step 2 comprises the following steps:
step 2.1: opening the long and short carbon fibers separately to disperse them into single ones; and
step 2.2: bringing the opened long and short fibers into the blender through the airflow fiber conveyor at the same time, mix the long and short fibers through the airflow, and subsequently introduce them into the airflow carding machine for further carding of the carbon fibers to form the carbon fiber non-woven paper sheets by the web formation technology;
wherein the airflow fiber conveyor and the airflow carding machine in step 2.2 use compressed air as the medium, the gas flow rate of the airflow fiber conveyor for long fibers is 25˜45 m/s, the gas flow rate of the airflow fiber conveyor for short fibers is 5˜20 m/s, and the gas flow rate of the airflow carding machine is 15˜35 m/s;
wherein the carbon fiber non-woven paper sheet in step 2 has a surface density of 5 to 40 g/m².

2-4. (canceled)

5. The method of claim 36, wherein the long and short fiber carbon fibers are opened separately using a double-roller fiber opener, with the air used as the dispersing medium, depending on a high-speed rotary roller.

6. The method of claim 5, wherein the speed of the roller for long fiber opening in step 2.1 is 4000˜7500 rpm; the speed of the roller for short fiber opening is 2000˜3000 rpm.

7. The method of claim 6, wherein the opened long and short fibers are simultaneously brought into the blender through the airflow fiber conveyor.

8-10. (canceled)

11. The method of claim 36, wherein the process of continuous heat treatment in step 4 is as follows: carbonize for 30˜180 min under the protection of nitrogen at 600 to 1100° C., followed by heat treatment for 30˜180 min under the protection of argon at 1400˜1800° C.

12. The method of claim 36, wherein the thermoplastic resin film is one or more of the following materials: thermoplastic phenolic resin film, epoxy resin film, polyethylene film, and polypropylene film; the resin film has a thickness of 0.01˜0.1 mm.

13. The method of claim 36, wherein the lamination involves a total of 3˜12 layers and the lamination is composed of a layer of thermoplastic resin film (A), a carbon fiber non-woven sheet (B), and a layer of thermoplastic resin film (A) in the form of (ABA), (ABABABA), (ABABABA), (ABABABABA), (ABABABABA), or (ABABABABABA) in turn circularly.

14. The method of claim 36, wherein:
the lamination involves a total of 3˜12 layers the lamination is composed of a layer of thermoplastic resin film (A), a carbon fiber non-woven paper sheet (B), two layers of thermoplastic resin film (AA), a carbon fiber non-woven paper sheet (B), and a layer of thermoplastic resin film (A) in the form of (ABAABA), (ABAABAABA), or (ABAABAABAABA).

15-34. (canceled)

35. A system for making the flexible rollable carbon paper in claim 1, comprising:
a short fiber cutting unit for cutting the carbon fiber to a desired shorter first length;
a long fiber cutting unit for cutting the carbon fiber to a second length longer than the first length;
a double-roller fiber opener for short fibers and a double-roller fiber opener for long fibers, for opening the cut short fibers and long fibers, respectively;
an airflow fiber conveyor for short fibers, and an airflow fiber conveyor for long fibers, for conveying short fibers and long fibers to the blender, and for mixing long fibers and short fibers in the blender;
an airflow carding machine for carding the mixed fibers output from the blender;
a wet formation unit for to web formation processing of the fibers into the airflow carding machine to form carbon fiber non-woven paper sheets;
a laminating machine for laminating the formed carbon fiber non-woven paper sheets to form carbon fiber;
a carbonizing unit for carbonizing the carbon fiber paper, and
a high-temperature treatment unit for graphitizing the carbon fiber paper that has been carbonized.

36. A method for preparing a flexible rollable carbon paper is composed of the following steps:
step 1: performing carbon fiber matching;
step 2: preparing carbon fiber non-woven paper sheets by non-woven technology;
step 3: laminating the surface of multiple carbon fiber non-woven paper sheets to form a carbon fiber paper; and
step 4: producing the flexible rollable carbon paper by continuous heat treatment;
wherein the process of surface lamination in step 3 is as follows: laminate a layer of thermoplastic resin film (A) and a carbon fiber non-woven paper sheet (B), and then heat press them using an automatic laminating machine at 100˜220° C. to form carbon fiber paper;
wherein the carbon fiber matching in step 1 includes short cutting the carbon fiber into long fibers of 25˜100 mm and short fibers of 1˜20 mm, controlling the mass ratio of long fibers and short fibers at 3:1˜1:3;
wherein the method of preparing the carbon fiber non-woven paper sheets in step 2 comprises the following steps:
step 2.1: opening the long and short carbon fibers separately to disperse them into single ones; and
step 2.2: bringing the opened long and short fibers into the blender through the airflow fiber conveyor at the same time, mix the long and short fibers through the airflow, and subsequently introduce them into the airflow carding machine for further carding of the carbon fibers to form the carbon fiber non-woven paper sheets by the web formation technology;
wherein the airflow fiber conveyor and the airflow carding machine in step 2.2 use compressed air as the medium, the gas flow rate of the airflow fiber conveyor for long fibers is 25˜45 m/s, the gas flow rate of the airflow fiber conveyor for short fibers is 5˜20 m/s, and the gas flow rate of the airflow carding machine is 15˜35 m/s;
wherein the carbon fiber non-woven paper sheet in step 2 has a surface density of 5 to 40 g/m².
